(19) United States
(12) Patent Application Publication
(10) Pub. No.: US 2004/0013299 A1
(43) Pub. Date: Jan. 22, 2004

(54) System and method for contrast enhanced registration with complex polynomial interpolation

(75) Inventor: Frank J. Crosby, Panama City, FL (US)

Correspondence Address: COASTAL SYSTEMS STATION, DAHLGREN DIVISION, NAVAL SURFACE WARFARE CENTER, 6703 W HWY 98 CODE CP2L, PANAMA CITY, FL, 32407-7001, US

(73) Assignee: The United States of America represented by the Secretary of the Navy

(21) Appl. No.: 10/196,386

(22) Filed: Jul. 12, 2002

(51) Int. Cl. G06K 9/00

(52) U.S. Cl. 382/168; 382/294

(57) ABSTRACT

A method of registering first and second images includes the steps of (a) accepting each of the first and second images, (b) contrast enhancing each of the first and second images to form enhanced first and second images, (c) sampling each of the enhanced first and second images to form sampled first and second images, (d) computing a correlation between the sampled first and second images, (e) computing a first coarse common area for the sampled first image and a second coarse common area for the sampled second image, (f) defining corresponding corner patches for each first and second coarse common area, (g) computing a correlation between each corresponding corner patch, and (h) defining a complex interpolating polynomial function based upon the correlation of step (g).

### GOVERNMENT RIGHTS

The invention described herein may be manufactured and used by or for the Government of the United State of America for governmental purpose without payment of any royalties thereon or therefor.

### BACKGROUND OF THE INVENTION

The present invention generally relates to image registration and, more specifically, to a system and method for contrast enhanced registration with complex polynomial interpolation.

Image registration is a process of determining a common scene in two images and giving the correspondence between the pixels in the common scene in one image with the pixels in the common scene in the other image. A conventional application is to video imagery taken from a moving platform. Since the platform is moving, each image contains a slightly different scene. Registering the images determines the scenery each image has in common. A function that maps one common area to the other represents how the pixels in each scene correspond. Other applications include medical imagery. In this imagery, the subject may have moved between successive images. The registration aligns the subject in one image with the subject in the other image.

Some known registration methods are based on a priori knowledge about the corresponding points in the images. These methods are known as point-based algorithms. The knowledge can be obtained either through the use of markers placed in the scene or naturally occurring landmarks. The objects that serve as markers must have a uniquely defined portion that can be associated with a single coordinate. The identified coordinates are paired in the two images.

Once the coordinates are known, construction of a function between the common areas is defined using single-valued functions that are defined on the images. A vector-valued function is made by pairing two or more single-valued functions. For example, in a two-dimensional case, a function T can be constructed using T₁ and T_{2:}

T(x, y) =[T₁(x, y), T₂(x, y)]where T₁ and T₂ are single valued functions.

Often in registration algorithms, the functions, Tᵢ(x, y), are assumed to have the same general form. In most cases, they are taken to be two-dimensional interpolation algorithms, such as bivariate polynomials or thin plate splines. While it is true that as maps from [symbol] ² to [symbol] these functions are theoretically well developed, mappings of the plane formed by pairing them are often not characterized very well.

Many images do not contain objects that are suitable for point-based registration. Rather than using a few points, other registration techniques rely on global similarity measures. These measures use most, if not all, of the pixels of each of the images to assess how they best align. A first step measures the similarity between the two images. Next, a transformation is applied and the similarity is recalculated. This process is repeated for a range of possible transformations. The transformation that gave the highest similarity is assumed to be the best.

Correlation is a global measure that is commonly used for registration. As disclosed in U.S. Pat. No. 6,295,083 to Kuhn, high precision image alignment detection uses an iterative part pixel shift detection algorithm to determine the displacement of a received image with respect to a reference image. An alignment pattern is inserted into the original image and a portion of the alignment pattern, such as a single line, also is stored as a reference image. Using cross-correlation, the received image is compared with the reference image to locate the alignment pattern, and selected portions of the received image alignment pattern are then used in conjunction with the reference image to determine the total pixel shift of the received image. An integer pixel shift is determined by cross-correlation of the received alignment pattern with the reference image. Using the integer pixel shift to identify a starting point, data is extracted from the received alignment pattern about a specific feature and a part pixel shift is measured. The received alignment pattern is then shifted by the part pixel shift, the data is again extracted and an additional part pixel shift is measured. These steps are iterated, using the sum of all prior part pixel shifts for each subsequent shift. At completion, the total of the integer pixel shift value and all the part pixel shift values determines the pixel shift required for registration of the received image vis-a-vis the original image.

The correlation between two images is another image. Pictorially, the correlation image is calculated by holding one image fixed and sliding, horizontally and vertically, the other image over it. Two exemplary images 100 (Image 1 or first image) and 110 (Image 2 or second image) are shown in FIG. 1. The sliding is represented in FIG. 2. At each point of the sliding, a value is computed by multiplying all of the overlapping pixels together. The value is a measure of how the two images fit together.

The correlation between two M ×N images is mathematically defined as

$${I}_{1} ( x , y ) ∘ {I}_{2} ( x , y ) = {\sum }_{m = 0}^{M - 1} {\sum }_{n = 0}^{N - 1} {I}_{1}^{*} ( m , n ) {I}_{2} ( x + m , y + n )$$

where * indicates complex conjugate. The point with the highest value in the correlation image represents the best translation alignment between the two images.

A manual translation between the first and second images, 100 and 110, is shown in FIG. 3. Image 300 shows second image 110 on top of first image 100 and image 310 shows first image 100 on top of second image 110. The images align with an offset that appears to be about 20 pixels horizontally and 100 pixels vertically.

A subset 400 of the correlation image is shown in FIG. 4. The subset 400 only corresponds to positive translations. However, negative translations are also computed. The bright area 410 roughly corresponds to location (20,100).

Several different global measures are known in the art. However, each involves a large number of calculations for even moderately sized images. Often adjacent pixels in an image have similar values and the individuality of each pixel can be lost through the many computations involved in a global similarity measure. Additionally, numerical errors due to finite computer precision can cause pixel values that were initially different to become identical. Therefore, a one-pixel shift between the two images can result in a small change in the similarity measure. Considering these limitations, the ability of prior art methods to find the true peak value of the similarity measure is reduced.

As can be seen, there is a need for a system and method of registering images that overcomes the disadvantages of the prior art. Such a system and method preferably provides for the preservation of information content. Further, such a system and method preferably maps distinct points from one image to distinct point in the other image thereby preventing loss of information. Finally, such a system and method preferably preserves angles in each image.

### SUMMARY OF THE INVENTION

In one aspect of the present invention, a method of registering first and second images includes the steps of (a) accepting each of the first and second images, (b) contrast enhancing each of the first and second images to form enhanced first and second images, (c) sampling each of the enhanced first and second images to form sampled first and second images, (d) computing a correlation between the sampled first and second images, (e) computing a first coarse common area for the sampled first image and a second coarse common area for the sampled second image, (f) defining corresponding corner patches for each first and second coarse common area, (g) computing a correlation between each corresponding corner patch, and (h) defining a complex interpolating polynomial function based upon the correlation of step (g).

In another aspect of the present invention, a method for registering first and a second images includes the steps of (a) accepting each of the first and second images; (b) contrast enhancing each of the first and second images by histogram equalization to form enhanced first and second images; (c) sampling each of the enhanced first and second images to form sampled first and second images such that a width and a length of the sampled first and second images are powers of prime numbers greater than one; (d) computing a correlation between the sampled first and second images and finding a peak (a, b) in a correlation image; (e) computing a first coarse common area for the sampled first image and a second coarse common area for the sampled second image such that first coarse common area includes a first set of points (x, y)_{first} wherein (x+a, y+b) is in the second image and such that second coarse common area includes a second set of points (x, y)_{second} wherein (x−a, y−b) is in the first image; (f) defining four corresponding corner patches for each first and second coarse common area; (g) computing a correlation between each corresponding corner patch and finding peaks (a, b)₁, (a, b)₂, (a, b)₃, (a, b)₄ in each of four correlation images; and (h) defining a complex interpolating polynomial function based upon the correlation of step (g) and using peaks (a, b)₁, (a, b)₂, (a, b)₃, (a, b)₄ and corresponding corner coordinates for each corner patch.

In yet another aspect of the present invention, a computer readable media for registering first and second images includes (a) a code segment for accepting each of the first and second images, (b) a code segment for contrast enhancing each of the first and second images to form enhanced first and second images, (c) a code segment for sampling each of the enhanced first and second images to form sampled first and second images, (d) a code segment for computing a correlation between the sampled first and second images, (e) a code segment for computing a first coarse common area for the sampled first image and a second coarse common area for the sampled second image, (f) a code segment for defining corresponding corner patches for each first and second coarse common area, (g) a code segment for computing a correlation between each corresponding corner patch; and (h) a code segment for defining a complex interpolating polynomial function based upon the correlation of step (g)

In another aspect of the invention, a system for registering a first and second image includes a memory coupled to a processor, the processor operable to (a) accept each of the first and second images, (b) contrast enhance each of the first and second images to form enhanced first and second images, (c) sample each of the enhanced first and second images to form sampled first and second images, (d) compute a correlation between the sampled first and second images, (e) compute a first coarse common area for the sampled first image and a second coarse common area for the sampled second image, (f) define corresponding corner patches for each first and second coarse common area, (g) compute a correlation between each corresponding corner patch, and (h) define a complex interpolating polynomial function based upon the correlation of step (g).

These and other features, aspects and advantages of the present invention will become better understood with reference to the following drawings, description and claims.

### BRIEF DESCRIPTION OF THE DRAWINGS

FIG. 1 illustrates two images;

FIG. 2 illustrates a prior art correlation process between the images of FIG. 1;

FIG. 3 illustrates a prior art correlation image;

FIG. 4 illustrates a subset of the correlation image of FIG. 3;

FIG. 5 illustrates a prior art schematic representation of a computer system;

FIG. 6 illustrates a flow chart of a method in accordance with an aspect of the present invention;

FIG. 7 illustrates an image of a grass field;

FIG. 8 illustrates a histogram of the image of FIG. 7;

FIG. 9 illustrates an enhanced image of the image of FIG. 7; and

FIG. 10 illustrates a histogram of the image of FIG. 7 after histogram equalization.

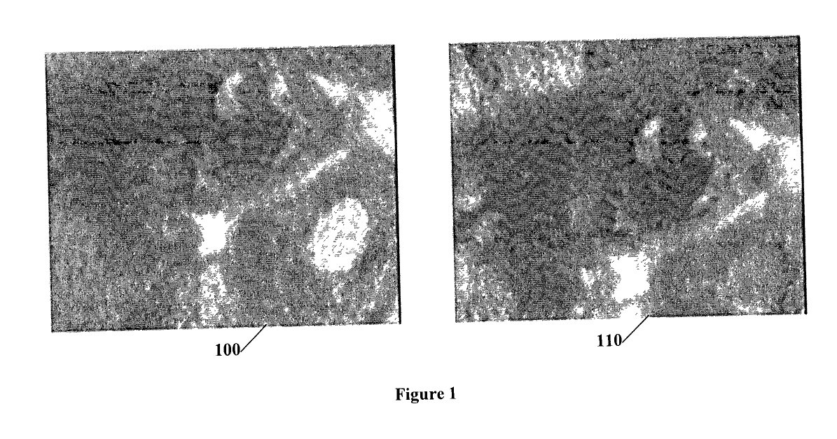

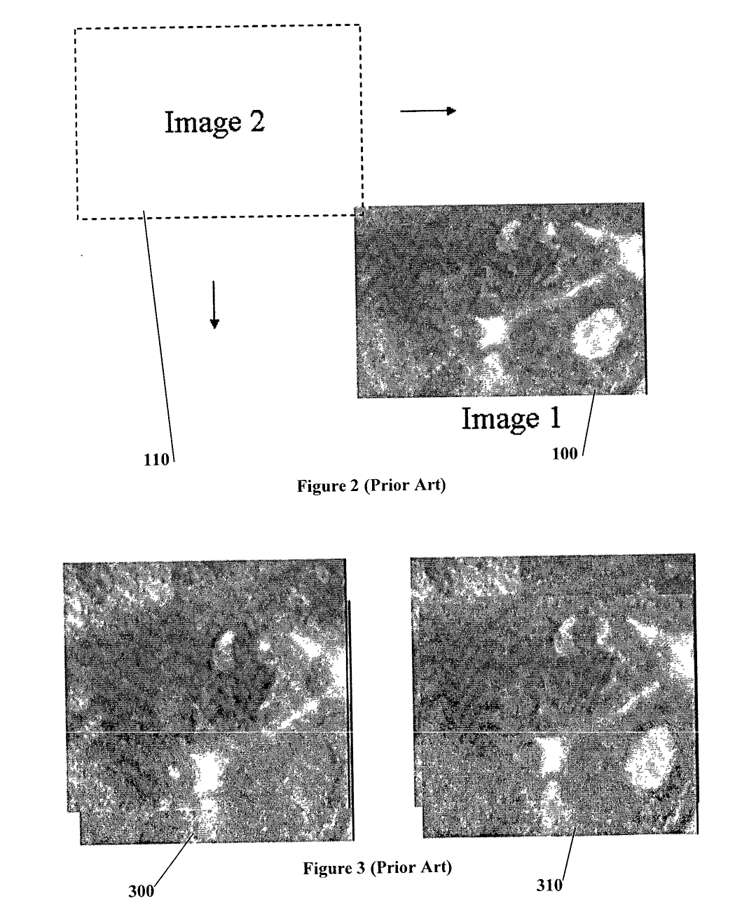

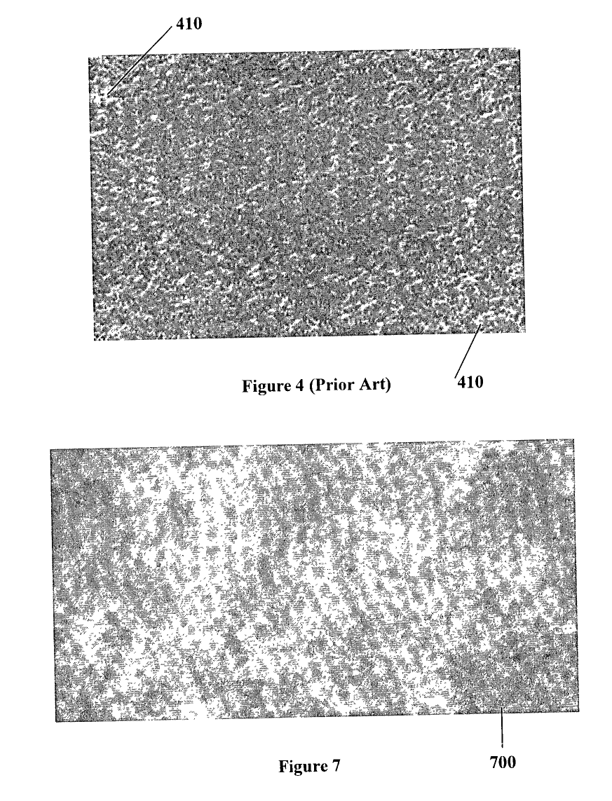

### DETAILED DESCRIPTION OF THE INVENTION(ON

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention generally provides a method for contrast enhanced registration with complex polynomial interpolation. The method includes the steps of inputting two images to be registered, performing histogram equalization on each image, sampling the images, computing a correlation between the sampled images, computing a coarse common area, defining corresponding corner patches for each image, computing a correlation for each corner patch, and defining a complex interpolating polynomial function. By constructing the function between the images as a complex interpolating polynomial, the method of the present invention preserves the information content of the registered images. In contrast to the systems and methods of the prior art, the present invention maps distinct point to distinct points and preserves the angles in the images.

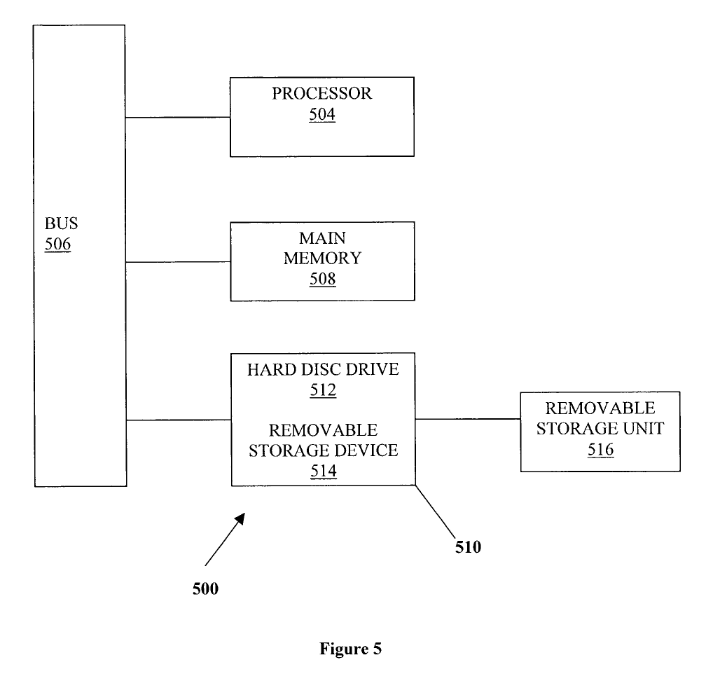

One embodiment of the present invention includes computer software executing within a computer system. FIG. 5 shows an exemplary computer system generally designated 500. The computer system 500 may include one or more processors, such as processor 504 connected to a bus 506.

The computer system 500 also may include a main memory 508, preferably random access memory (RAM), and a secondary memory 510. The secondary memory 510 may include a hard disk drive 512 and a removable storage device 514, such as a floppy disk drive, a magnetic tape drive, and a compact disk drive. The removable storage drive 514 reads from and writes to a removable storage unit 516 in any manner well known in the art.

Removable storage unit 516, also called a program storage device or a computer program product, represents computer readable media which may include a floppy disk, magnet tape, and a compact disk. The removable storage unit 516 may include a computer usable storage medium having therein stored computer software and data.

Computer programs (also called computer control logic) may be stored in main memory 508 and secondary memory 510. Such computer programs, when executed, enable the computer system 500 to perform the functions of the present invention as further described herein. In particular, the computer programs, when executed, enable the processor 504 to perform the functions of the present invention. Accordingly, such computer programs represent controllers of the computer system 500.

Alternative embodiments of the present invention are directed to a computer program product comprising a computer readable medium having code segments (computer software or control logic) stored therein. The code segments, when executed by the processor 504, causes the processor 504 to perform the functions as further described herein.

Further embodiments of the present invention are implemented primarily in hardware using, for example, a hardware state machine (not shown). Implementation of the hardware state machine so as to perform the functions described herein will be apparent to persons skilled in the relevant arts.

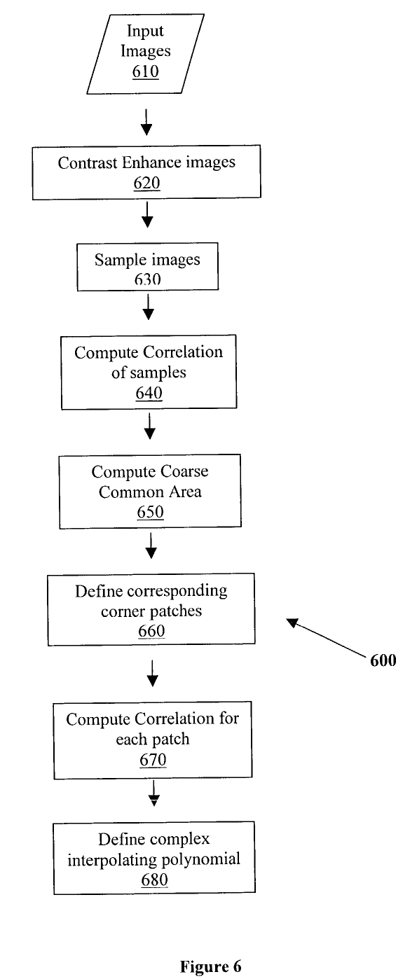

With reference to FIG. 6, an embodiment of the present invention includes a method generally designated 600 for defining a complex interpolating polynomial function. In a step 610, a first image and a second image are input to the process. Each image is then contrast enhanced in a step 620 as further described herein. In a step 630, each enhanced image is sampled and, in a step 640, a correlation between the sampled images is computed. A coarse common area for each sampled image is computed in a step 650, and in a step 660 corresponding corner patches in each coarse common area are defined. In a step 670, a correlation for each corresponding corner patch is computed. Finally, in a step 680, a complex interpolating polynomial function is defined.

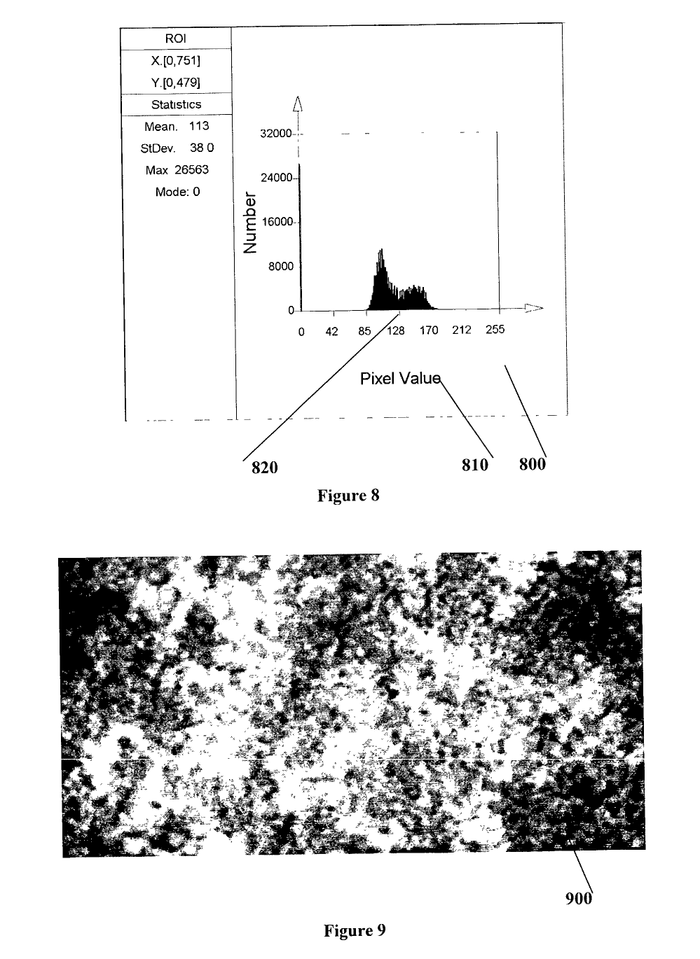

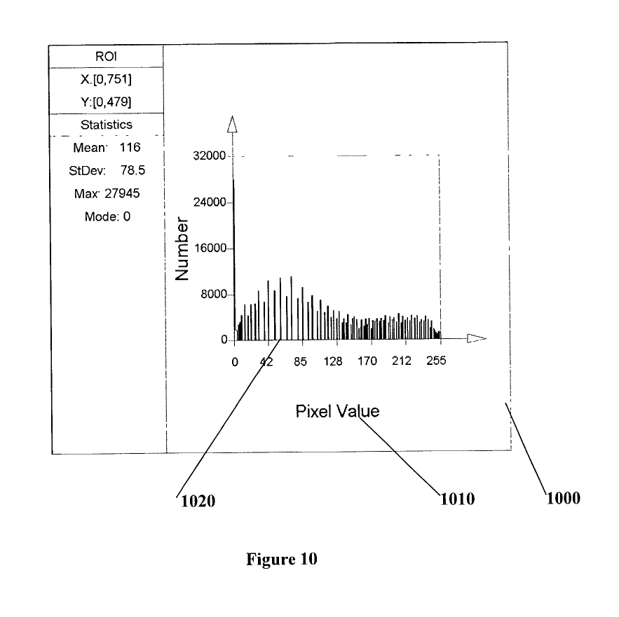

In an aspect of the invention, each image is contrast enhanced using histogram equalization to increase its dynamic range in the step 620. With reference to FIG. 7, there is shown a low contrast image 700 of a grass field. A histogram 800 of the image 700 is shown in FIG. 8. As shown, the range of values 810 is compressed into a center 820 of the spectrum. After histogram equalization, and with reference to FIG. 9, the image 700 is transformed into image 900 showing more prominent features. A corresponding histogram 1000 is shown in FIG. 10 and includes a range of values 1010 spread across all available values 1020. The first and second images may alternatively be contrast enhanced using histogram specification.

In another aspect of the invention, in the step 630, a sampling of each image is selected that results in a width and length that are powers of small prime numbers greater than one.

In another aspect of the invention, the step 640 further includes finding a peak (a,b) in a correlation image.

In yet another aspect of the invention, a coarse common area for each image is computed in step 640 such that for a first image a first coarse common area is a first set of points (x, y) such that (x+a, y+b) is in a second image. In similar fashion, for the second image a second coarse common area is a second set of points (x, y) such that (x−a, y−b) is in the first image.

In another aspect of the invention, the step 660 includes defining four corner patches of each of the first and second coarse common areas such that each corner patch has a same length/width ratio as the first and second images respectively and is defined such there is no overlap among the corner patches.

In yet another aspect of the invention, the step 670 further includes finding correlation peaks (a, b)₁, (a, b)₂, (a, b)₃, and (a, b)₄ for each of the four corner patches.

In another aspect of the invention, the step 680 further includes defining the complex interpolating polynomial function using the correlation peaks (a, b)₁, (a, b)₂, (a, b)₃, and (a, b)₄ and outside corner coordinates for each corner patch such that (x, y)₁→(w+a, z+b)₁, (x, y)₂→(w+a, z+b)₂, (x, Y)₃→(w+a, z+b)₃, (x, Y)₄→(w+a, z+b)₄, where (x, y)₁ is the outside corner for the first image, first corner patch, and (w, z)₁ is the outside corner of the second image, first patch, and so on.

As can be appreciated by those skilled in the art, the method of the present invention provides for contrast enhanced registration with complex polynomial interpolation. By constructing the function between the images as a complex interpolating polynomial, the method of the present invention preserves the information content of the registered images.

It should be understood, of course, that the foregoing relates to preferred embodiments of the invention and that modifications may be made without departing from the spirit and scope of the invention as set forth in the following claims.

We claim:

1. A method of registering first and second images comprising the steps of:
(a) accepting each of the first and second images;
(b) contrast enhancing each of the first and second images to form enhanced first and second images;
(c) sampling each of the enhanced first and second images to form sampled first and second images;
(d) computing a correlation between the sampled first and second images;
(e) computing a first coarse common area for the sampled first image and a second coarse common area for the sampled second image;
(f) defining corresponding corner patches for each first and second coarse common area;
(g) computing a correlation between each corresponding corner patch; and
(h) defining a complex interpolating polynomial function based upon the correlation of step (g).

2. The method of claim 1, wherein step (b) further comprises histogram equalization.

3. The method of claim 1, wherein step (b) further comprises histogram specification.

4. The method of claim 1, wherein step (c) further comprises sampling each of the first and second images such that a width and a length of the sampled first and second images are powers of prime numbers greater than one.

5. The method of claim 1, wherein step (d) further comprises finding a peak (a, b) in a correlation image.

6. The method of claim 5, wherein step (e) further comprises computing the first coarse common area as a first set of points (x, y)_{first} such that (x+a, y+b) is in the second image and computing the second coarse common areas as a second set of points (x, y)_{second} such that (x−a, y−b) is in the first image.

7. The method of claim 1, wherein step (f) further comprises defining four corresponding corner patches.

8. The method of claim 1,wherein step (g) further comprises finding a peak (a, b)ₙ in each of a plurality of correlation images.

9. The method of claim 8, wherein step (f) further comprises defining the complex interpolating polynomial function using the peaks (a, b)ₙ and a plurality of corresponding corner coordinates for each corner patch.

10. A method of registering first and second images comprising the steps of:
(a) accepting each of the first and second images;
(b) contrast enhancing each of the first and second images by histogram equalization to form enhanced first and second images;
(c) sampling each of the enhanced first and second images to form sampled first and second images such that a width and a length of the sampled first and second images are powers of prime numbers greater than one;
(d) computing a correlation between the sampled first and second images and finding a peak (a, b) in a correlation image;
(e) computing a first coarse common area for the sampled first image and a second coarse common area for the sampled second image such that first coarse common area includes a first set of points (x, y)_{first} wherein (x+a, y+b) is in the second image and such that second coarse common area includes a second set of points (x, y)_{second} wherein (x−a, y−b) is in the first image;
(f) defining four corresponding corner patches for each first and second coarse common area;
(g) computing a correlation between each corresponding corner patch and finding peaks (a, b)₁, (a, b)₂, (a, b)₃, (a, b)₄ in each of four correlation images; and
(h) defining a complex interpolating polynomial function based upon the correlation of step (g) and using peaks (a, b)₁, (a, b)₂, (a, b)₃, (a, b)₄ and corresponding corner coordinates for each corner patch.

11. A computer readable media for registering first and second images, the computer readable media comprising:
(a) a code segment for accepting each of the first and second images;
(b) a code segment for contrast enhancing each of the first and second images to form enhanced first and second images;
(c) a code segment for sampling each of the enhanced first and second images to form sampled first and second images;
(d) a code segment for computing a correlation between the sampled first and second images;
(e) a code segment for computing a first coarse common area for the sampled first image and a second coarse common area for the sampled second image;
(f) a code segment for defining corresponding corner patches for each first and second coarse common area;
(g) a code segment for computing a correlation between each corresponding corner patch; and
(h) a code segment for defining a complex interpolating polynomial function based upon the correlation of step (g).

12. The computer readable media of claim 11, wherein the code segment for contrast enhancing each of the first and second images to form enhanced first and second images further comprises a code segment for performing histogram equalization.

13. The computer readable media of claim 11, wherein the code segment for contrast enhancing each of the first and second images to form enhanced first and second images further comprises a code segment for performing histogram specification.

14. The computer readable media of claim 11, wherein the code segment for sampling each of the enhanced first and second images to form sampled first and second images further comprises a code segment for sampling each of the first and second images such that a width and a length of the sampled first and second images are powers of prime numbers greater than one.

15. The computer readable media of claim 11, wherein the code segment for computing a correlation between the sampled first and second images further comprises a code segment for finding a peak (a, b) in a correlation image.

16. The computer readable media of claim 15, wherein the code segment for computing a first coarse common area for the sampled first image and a second coarse common area for the sampled second image further comprises a code segment for computing the first common area as a first set of points (x, y)_{first} such that (x+a, y+b) is in the second image and computing the second coarse common areas as a second set of points (x, y)_{second} such that (x−a, y−b) is in the first image.

17. The computer readable media of claim 11, wherein the code segment for defining corresponding corner patches for each first and second coarse common area further comprises a code segment for defining four corresponding corner patches.

18. The computer readable media of claim 11, wherein the code segment for computing a correlation between each corresponding corner patch further comprises a code segment for finding a peak (a, b)ₙ in each of a plurality of correlation images.

19. The computer readable media of claim 18, wherein the code segment for defining a complex interpolating polynomial function further comprises a code segment for defining the complex interpolating polynomial function using the peaks (a, b)ₙ and a plurality of corner coordinates for each corner patch.

20. A system for registering a first and second image comprising:
a memory coupled to a processor, the processor operable to (a) accept each of the first and second images, (b) contrast enhance each of the first and second images to form enhanced first and second images, (c) sample each of the enhanced first and second images to form sampled first and second images, (d) compute a correlation between the sampled first and second images, (e) compute a first coarse common area for the sampled first image and a second coarse common area for the sampled second image, (f) define corresponding corner patches for each first and second coarse common area, (g) compute a correlation between each corresponding corner patch, and (h) define a complex interpolating polynomial function based upon the correlation of step (g).

21. The system of claim 20, wherein step (b) further comprises histogram equalization.

22. The system of claim 20, wherein step (b) further comprises histogram specification.

23. The system of claim 20, wherein step (c) further comprises sampling each of the first and second images such that a width and a length of the sampled first and second images are powers of prime numbers greater than one.

24. The system of claim 20, wherein step (d) further comprises finding a peak (a, b) in a correlation image.

25. The system of claim 24, wherein step (e) further comprises computing the first coarse common area as a first set of points (x, y)_{first} such that (x+a, y+b) is in the second image and computing the second coarse common areas as a second set of points (x, y)_{second} such that (x−a, y−b) is in the first image.

26. The system of claim 20, wherein step (f) further comprises defining four corresponding corner patches.

27. The system of claim 20, wherein step (g) further comprises finding a peak (a, b)ₙ in each of a plurality of correlation images.

28. The system of claim 27, wherein step (h) further comprises defining the complex interpolating polynomial function using the peaks (a, b)ₙ and a plurality of corresponding corner coordinates for each corner patch.
